(19) United States
(12) Patent Application Publication
(10) Pub. No.: US 2015/0072331 A1
(43) Pub. Date: Mar. 12, 2015

(54) SYSTEM AND COMPUTER PROGRAM PRODUCT FOR PROVIDING EDUCATIONAL SERVICES

(71) Applicant: Seth Brown, Dallas, TX (US)

(72) Inventor: Seth Brown, Dallas, TX (US)

(73) Assignee: BROWN-KUPOR ENTERPRISES, LLC, Dallas, TX (US)

(21) Appl. No.: 14/021,219

(22) Filed: Sep. 9, 2013

(51) Int. Cl. G09B 5/02

(52) U.S. Cl. CPC G09B 5/02
USPC 434/322

(57) ABSTRACT

A system and computer program product for providing educational services. The system includes a plurality of remote computers, a central server, a network interface in communication with the central server and the plurality of remote computers over a network, a shared database in communication with the central server. The network interface is configured to provide educational services. The central server is configured to receive and store educational information in the shared database. The educational information includes a plurality of outlines and a plurality of animation data. The outlines include one or more topics. Each topic has one or more elements, and the one or more elements are linked to one or more of the plurality of animation data. The central server is further configured to load the linked one or more animation data from the shared database when the user selects at least one of the one or more elements corresponding to the linked one or more animation data, and play the loaded one or more one or more animation data on at least one of the plurality of remote computers.

### BACKGROUND OF THE INVENTION

1. Field of the Invention

The present invention is generally related to educational services, and more particularly to a system and computer program product for providing educational services.

2. Discussion of the Background

People are often interested in gaining knowledge, learning information for classes, memorizing information for examinations, tests, work, and the like. However, traditional techniques do not always provide an effective learning environment that fully engages that person. Typically, no consideration is given to alternate learning techniques and presenting the information in an entertaining way that fully engages the person and thereby maximizes it effectiveness for the information being presented.

Thus, there currently exist deficiencies associated with educational services, and, in particular, with providing educational services.

### SUMMARY OF THE INVENTION

Accordingly, one aspect of the present invention is to provide a system for providing educational services. The system includes a plurality of remote computers, a central server, a network interface in communication with the central server and the plurality of remote computers over a network, a shared database in communication with the central server. The network interface is configured to provide educational services. The central server is configured to receive and store educational information in the shared database. The educational information includes a plurality of outlines and a plurality of animation data. The outlines include one or more topics. Each topic has one or more elements, and the one or more elements are linked to one or more of the plurality of animation data. The central server is further configured to load the linked one or more animation data from the shared database when the user selects at least one of the one or more elements corresponding to the linked one or more animation data, and play the loaded one or more one or more animation data on at least one of the plurality of remote computers.

Another aspect of the present invention is to provide a computer program product embodied on a non-transitory computer readable medium for providing educational services. The computer program is implemented by one or more processors executing processor instructions. The computer program product includes a first computer code for receiving configuration and setup information, a second computer code for displaying one or more of the plurality of animation files to the user when one or more of the elements are selected, a third computer code for receiving and storing practice test information in the database, and a fourth computer code for presenting one or more practice tests to the user. The practice test information includes responses to practice test questions. The configuration and setup information includes a plurality of outlines, games and animation files. The outlines include one or more topics, each topic having one or more elements. One or more of the elements is linked to the animation files.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1F are block diagrams illustrating a system for providing educational services in accordance with an embodiment of the present invention;

FIGS. 2A-2D are flow charts illustrating a method for providing educational services in accordance with an embodiment of the present invention; and

FIGS. 3A-3P illustrate exemplary user interfaces for providing educational services in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

People are often interested in gaining knowledge, learning information for classes or training, memorizing information for examinations, tests, work and the like. This may or may not require memorization of large amounts of information, such as without limitation, preparing for a state law bar or multi-state examinations, medical examinations, professional engineering certifications, accounting certifications, and the like. The present invention provides a system, computer program and method of providing educational services that is more entertaining and engaging than traditional techniques and thereby provides a more effective learning environment for the user. The system is generally configured to provide learning through the use of, without limitation, animated objects and cartoons, videos, outlines, audio presentations, electronic flash cards, structured questions and answers, games, and the like. According to one embodiment, the animated objects and cartoons are provided using Adobe Flash. According to another embodiment, the animated objects and cartoons are provided using HTML5, CSS3 and JavaScript. However, it is understood that the present invention is not intended to be limited to such and that any other means of providing animated objects and cartoons is possible within the scope of the present invention. For example, the present invention may utilize any video and/or audio technology or file including, without limitation, AVI, MPG, MPEG, WMV, MP4, M4V, ASF, MOV, QT, 3GP, DAT, OGM, RM, RMVB, FLV, MKV, DVR-MS, TS, VRO, F4V, MTS, M2TS to AVI, MPEG, MOV, WMV, MP4, RM, Apple TV, 3GP, FLV, SWF, and the like.

### I. System for Providing Educational Services

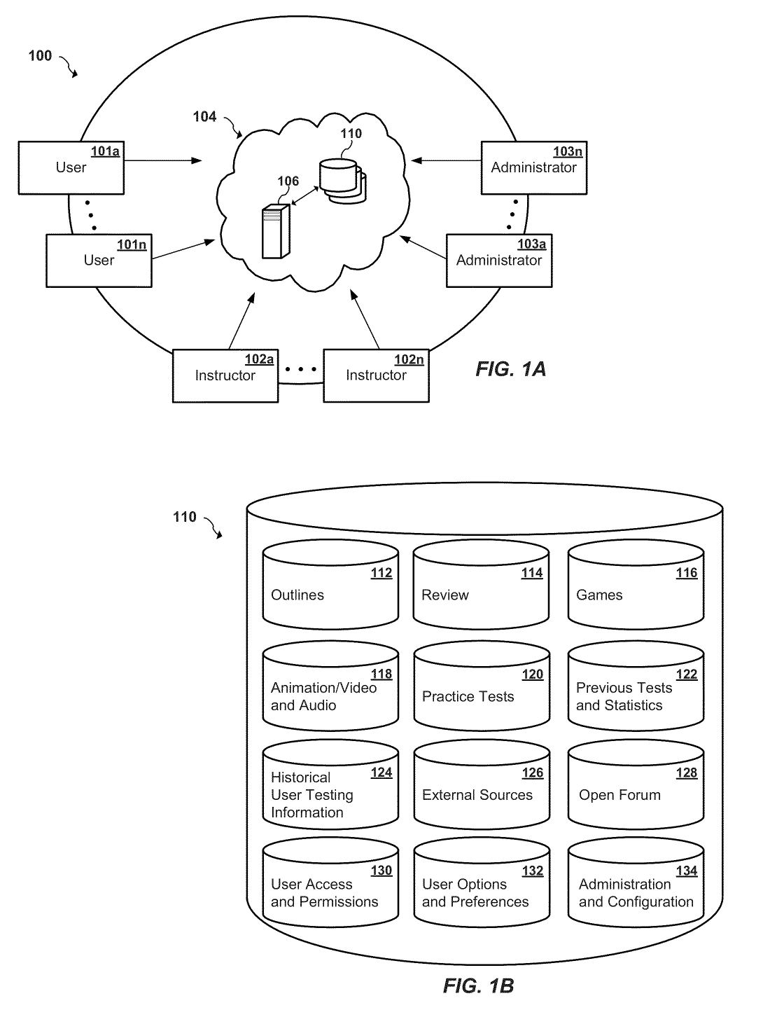

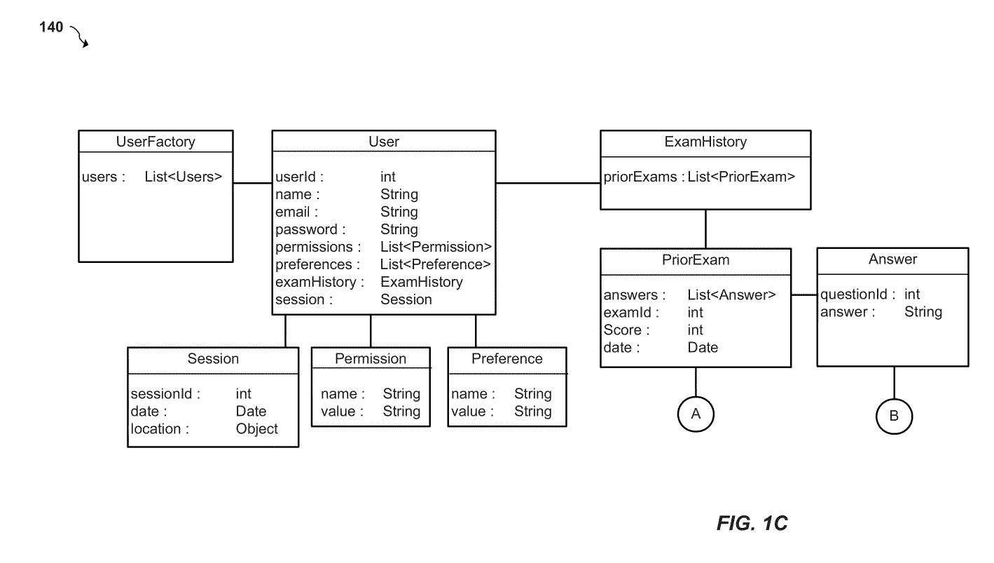

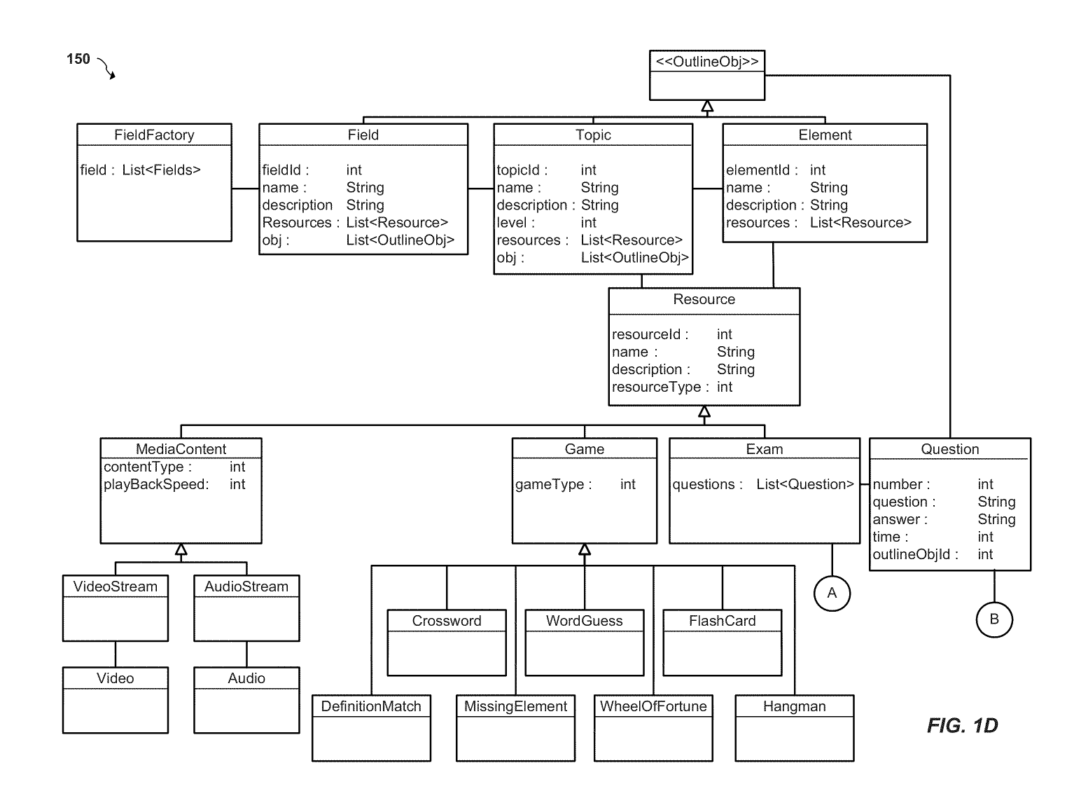

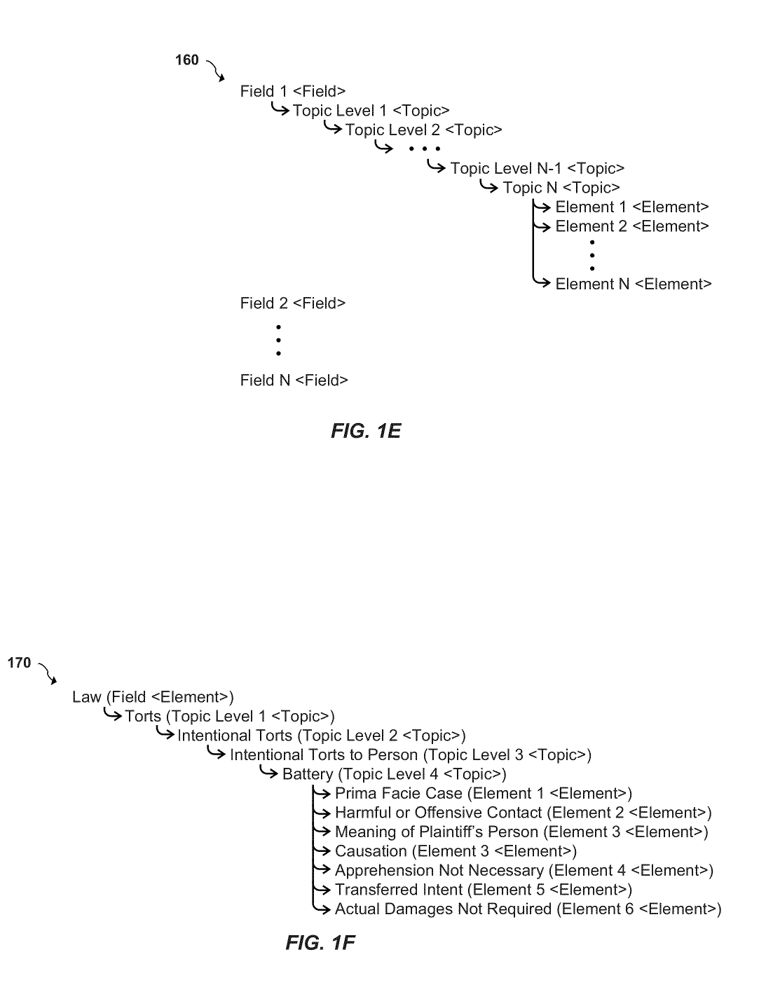

Referring to FIGS. 1A-1F, block diagrams illustrating a system 100 for providing educational services in accordance with an embodiment of the present invention are shown. The system 100 includes one or more computers and/or servers 106 in communication with one or more databases 110. According to one embodiment, the one or more databases 110 include without limitation an outline data 112, review data 114, games data 116, animation/video and audio data 118, practice tests data 120, previous tests and statistics data 122, historical user testing information 124, external sources data 126, open forum data 128, user access and permissions 130, user options and preferences data 132, and administration and configuration data 134. It is understood, however, that other databases and/or combinations thereof are possible within the scope of the present invention.

According to one embodiment, one or more users (101a-101n), one or more instructors (101a-101n) and/or one or more administrators (101a-101n) may access the system 100 using an interface device via a network 104. The system may utilize, without limitation, a secure socket connection to a web server running on the system 100. The interface device may include without limitation a computer, laptop, PDA, smart phone, server, network device, and the like. The network may include without limitation the Internet, Intranet, LAN, WAN, proprietary network, and the like. The one or more users (101a-101n), one or more instructors (101a-101n) and/or one or more administrators (101a-101n) may utilize a web browser or other software and/or hardware to communicate with the system 100. According to an alternate embodiment, the system 100 is a standalone version loaded on a computer of the one or more users (101a-101n), one or more instructors (101a-101n) and/or one or more administrators (101a-101n), which may or may not include a network.

Each user 101, instructor 102 and/or administrator 103, having the appropriate permission, has the ability to access the user interfaces and modules of the system 100, or portions thereof, and to drill down from a particular topic to the individual elements of the particular topic using a simple to use, intuitive interface. A web-based graphic user interface allows the user 101, instructor 102 and/or administrator 103 to access the user interfaces of the system 100 or portions thereof. According to an alternate embodiment, a user 101, instructor 102 and/or administrator 103 accesses the user interfaces in a standalone configuration. In this alternate embodiment, the software may be installed locally on a standalone computer or device rather than utilizing a web server.

As used herein, a user 101 is person who is interested in gaining knowledge, learning information for classes or training, memorizing information for examinations, tests, work and the like. A user 101 is typically provided access permission to the user interfaces and modules of the system 100 that allow the user 101 to gain knowledge or learn information, and to configure options and preferences for that particular user 101.

As used herein, an instructor 102 is a person who provides knowledge or information to one or users (101a-101n) using the user interfaces of the system 100. The instructor 102 is typically provided access permission to the user interfaces and modules of the system 100 that allow the instructor to (i) provide video, audio or chat with one or more users; (ii) create and associate one or more field of study objects, topic objects, element objects, and resource objects (e.g., media content objects, game objects, exam objects, and the like) as described herein; and (iii) review the practice exam history of one or more users (101a-101n). Said another way, the instructor 102 is typically provided access permission to the user interfaces and modules of the system 100 that allow the instructor to provide a virtual training environment in which the instructor may construct a curriculum, interact with the users 101 (or students), and monitor the improvements and weaknesses of the users 101.

As used herein, an administrator 103 is a person who configures portions of the system 100 and may be either a system administrator or a client administrator. A system administrator is typically an employee of, or associated with, the entity hosting and/or maintaining the system 100 and is typically granted full permission to all user interfaces, modules, settings and configurations of the system 100. A client administrator is typically an employee of, or associated with, a third party entity (e.g., a client of the entity hosting and/or maintaining the system) that wishes to provide knowledge or information to a subset of the one or users (101a-101n), and is typically granted limited permission to the user interfaces, modules, settings and configurations of the system 100. For example, the third party entity may be a teaching facility that that has a paid contract with the entity hosting and/or maintaining the system 100 for access to such, and wants to provide training to one or more students of its physical or virtual teaching facility. In addition to having access permission to the administrative user interfaces, modules, settings and configurations of the system 100 as described above, an administrator 102 will also typically be provided access permission to the user interfaces and modules of the system 100 that that an instructor 102 and a user 101 would have access.

Referring to FIGS. 1C-1D, block diagrams illustrating exemplary entity-relationship diagrams (140 and 150) of the system 100 for providing educational services in accordance with an embodiment of the present invention are shown. As shown in FIG. 1C, the system 100 includes one or more user objects that may be created using a user factory object. Each user object may include, without limitation, a user identification, a name, an email address, a password, permission information, user options and preferences, session information, exam history information, and the like.

The permission information and the user options and preferences may be stored using any means, including, without limitation, name-value pairs. The permissions information may identify different user interfaces of the system 100 and/or portions thereof to which the user 101, instructor 102, and/or administrator 103 have access. The permissions information may also identify different or modules/functionality of the system 100 or portions thereof that the user 101, instructor 102, and/or administrator 103 have access.

The user options and preferences may include, without limitation, which topics, subtopics and/or elements the user 101 desires to exclude or include and/or provide additional attention. For example, the options and preferences may include the option for the user 101 to associate a number with one or more topics, subtopics and/or elements. This number may be used during practice tests to increase or reduce the number of questions presented in those areas. According to one possible non-limiting implementation, each of the topics, subtopics and/or elements is provided with a graphical slider that is adjustable from 0 to 10, where 5 is the default and adjusting the slider in either direction increases or reduces respectively the number of times those questions are presented.

The session information may include, without limitation, information such the system 100 may maintain and display to the user 101 the last user interface accessed during the previous login session. The session information may also include other pertinent information that needs to be maintained between login sessions.

The exam history may include, without limitation, scores and answers that the user 101 provided in previous practice tests. The particular topic(s), subtopic(s) and/or element(s) associated with each question is also maintained so that the system 100 can track which topic(s), subtopic(s) and/or element(s) the user 101 needs additional study. This information may be presented to the user in text form or graphically using a graphical chart showing a timeline of improvement in different areas. This information may also be used by the system 100 to automatically increase the number of questions in a particular topic, subtopic and/or element in which the user 101 needs additional study. Thereby, the system 100 can dynamically adjust the practice tests to the particular needs of the user 101.

As shown in FIG. 1D, the system 100 includes one or more field of study objects that may be created using a field factory object. Each field of study object may include, without limitation, a name, a description, a level and one or more outline objects (which may be either topic objects or element objects). Each topic object may include, without limitation, a name, a description, level and one or more outline objects (which may be either topic objects or element objects). As shown in FIGS. 1E-1F, by linking the field objects and topic objects to either other topic objects or element objects, the system 100 may handle hierarchies of varying levels depending on the particular field of study. The level is used to indicate the outline objects relative position within the hierarchical structure.

Each field, topic, and element object may also include, without limitation, one or more resource objects. Each resource object may include, without limitation, a media content object, a game object, an exam object, and the like.

Each media content object represents an animation/video and/or audio file or data. The media content object may also include, without limitation, a content type identifier, a playback speed, and the like. Other information relating to the specific type of animation/video and/or audio file or data may also be included in the media content object.

Each game object represents different game objects, such as without limitation, a crossword puzzle game, a word guess game, a flash card game, a definition match game, a missing element game, a wheel of fortune game, a hangman game, and the like. Each of these games are designed to help the user 101 memorize certain topics, terms, concepts, definitions, and the like. As such, any memory related game may be implemented by a game object within the scope of the present invention.

Each exam object represents a practice test and may include, without limitation, one more question objects. Each question object may include, without limitation, a question number, a question, an answer, and the like. The question object may also include which field, topic, or element the question is associated with, along with a time duration (typically in seconds) in which the user has to answer the question before the next question is displayed.

It is understood, however, that the entity-relationship diagrams shown in FIGS. 1C-1D are shown for exemplary purposes and that other objects, fields, relationships and/or combinations thereof are possible within the scope of the present invention.

According to one non-limiting embodiment, the system 100 includes user interfaces that allow the one or more instructors (102a-102n) and the one or more administrators (103a-103n) create and associate the objects, fields and relationships shown in FIGS. 1C-1D graphically using drag and drop operations. According to this embodiment, each of the objects is represented by graphical icons which may be added simply by dragging the icons into a work space graphically displayed within the user interface. The objects would include default values for the fields contained therein. These values may be modified by the one or more instructors (102a-102n) and/or the one or more administrators (103a-103n) by clicking on the particular object and editing those fields using a text field, slider, scale, or other appropriate form field (e.g., using, without limitation, HTML form elements, or similar form related fields). The relationships can be specified by connecting lines between the graphical representations of the objects. As one of ordinary skill in the art would understand, this is similar to the functionality provided by entity-relationship diagram tools which are commercially available by numerous vendors. Further, pre-defined templates may be utilized as a starting point to help simplify this process. Thereby, the system 100 is configured to provide an intuitive interface for creating and associating one or more field of study objects, topic objects, element objects, and resource objects (media content objects, game objects, exam objects, and the like) as described herein, without requiring the one or more instructors (102a-102n) and/or the one or more administrators (103a-103n) to understand the underlying programming that is required to create and associate such objects.

### II. Processing for Providing Educational Services

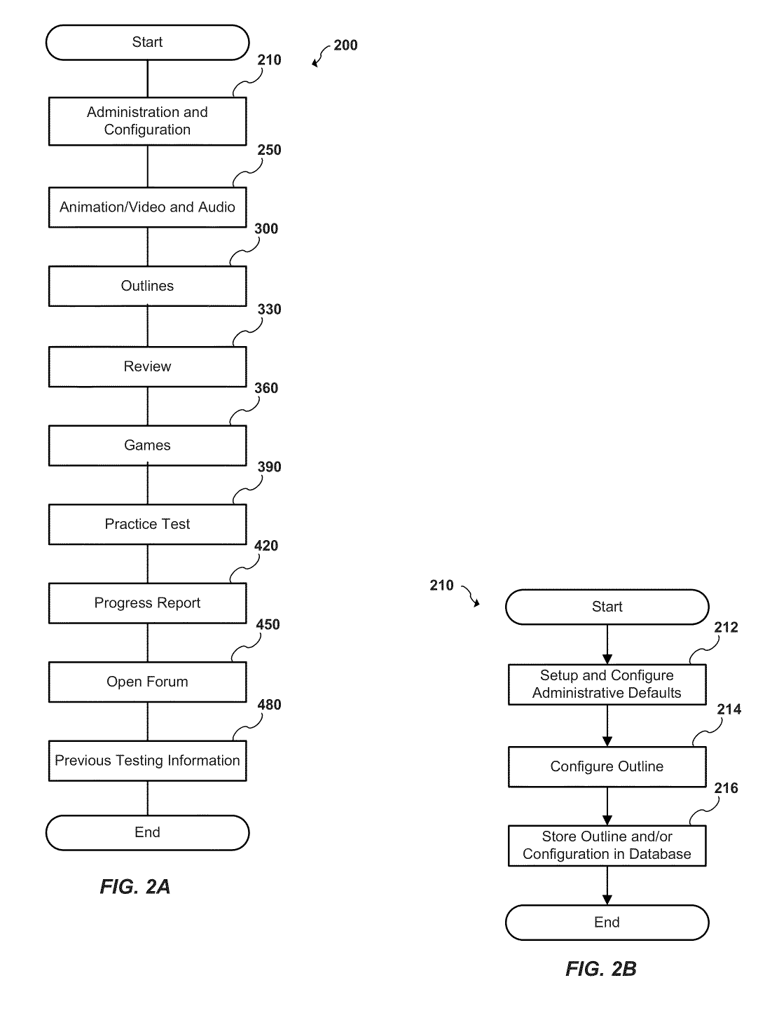

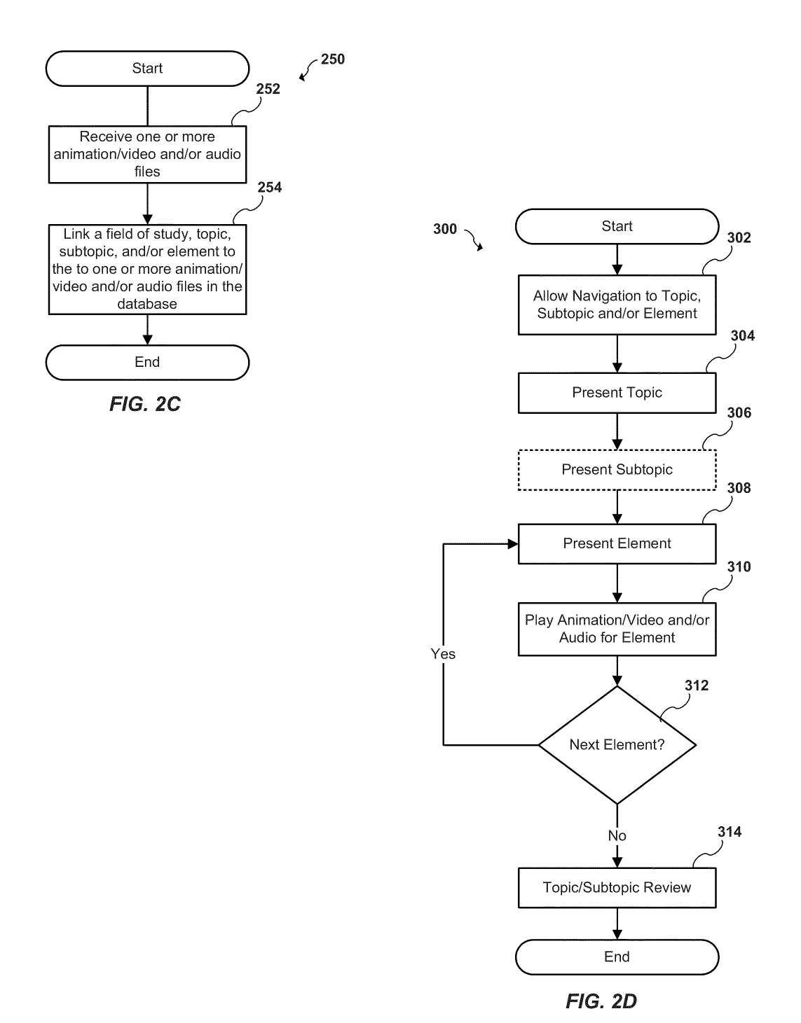

Referring to FIGS. 2A-2D, flow charts illustrating a method for providing educational services in accordance with an embodiment of the present invention, are shown. The system 100 includes without limitation modules for administration and configuration 210, animation/video and audio 250, outlines 300, review 330, games 360, practice test 390, progress report 420, open forum 450 and previous testing information 480. It is understood that these modules may be accessed in any order and that other modules and/or combinations thereof are possible within the scope of the present invention.

### Administrative Module

The system 100 includes an administration and configuration module 210 that is used by an administrator 103 to setup and configure the system 100. An administrator 103 may connect via a secure socket connection to configure the system 100. An output manipulator may be utilized by an administrator 103 to further customize the output data for the user 101. Using the output manipulator, the administrator 103 can select what media content data, user interfaces and/or modules are to be presented to the user 101.

User database 124 may include, without limitation, user name, user identification (ID), password, profile, permission, and the like. Each user 101 may be associated without limitation with the outline data 112, review data 114, games data 116, animation/video and audio data 118, practice tests data 120, previous tests and statistics data 122, historical user testing information 124, external sources data 126, open forum data 128, and options and preferences data 132.

Referring to FIG. 2B, a flow chart illustrating the administration and configuration module 210 for providing educational services in accordance with an embodiment of the present invention, is shown. At block 212, the system 100 receives setup and configuration information. Such setup and configuration information may include without limitation branding information, options, managing users and permissions, loading files, and associating animation/video and/or audio with outline elements. The setup and configuration information also include, without limitation, managing users, report options, practice test options, animation/video options, audio options, review options, outline options, forum options and game options. The outlines are configured at block 214. At block 216, outline and/or configuration information is stored in the database 110.

### Animation/Video and Audio Module

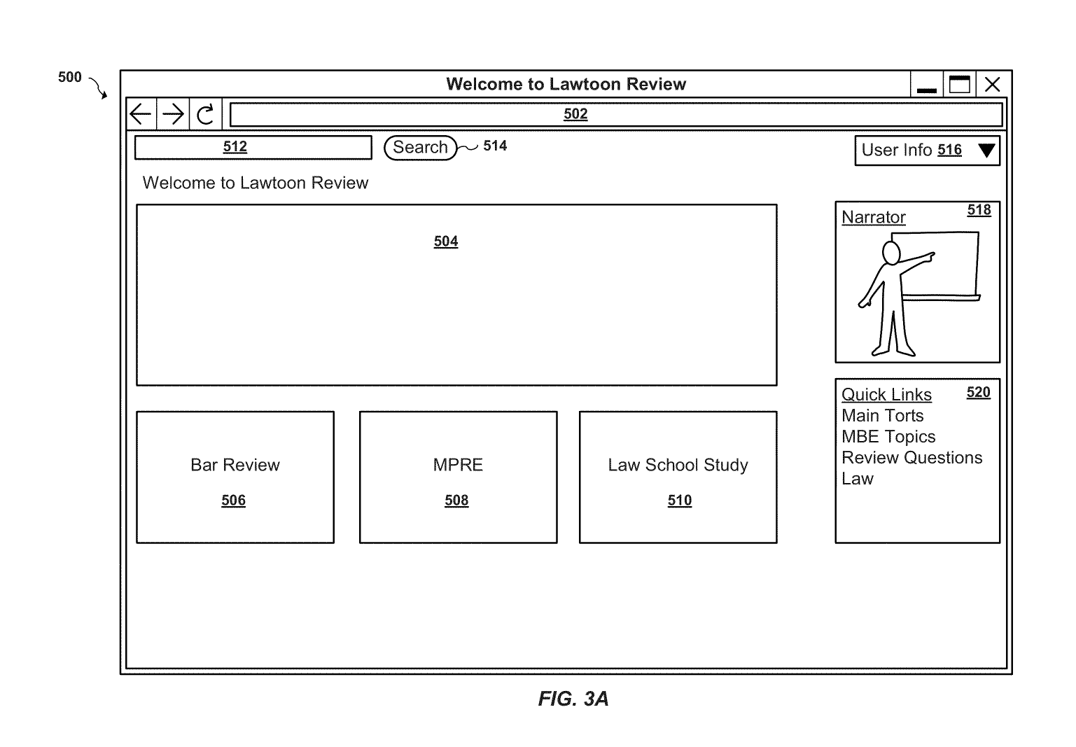

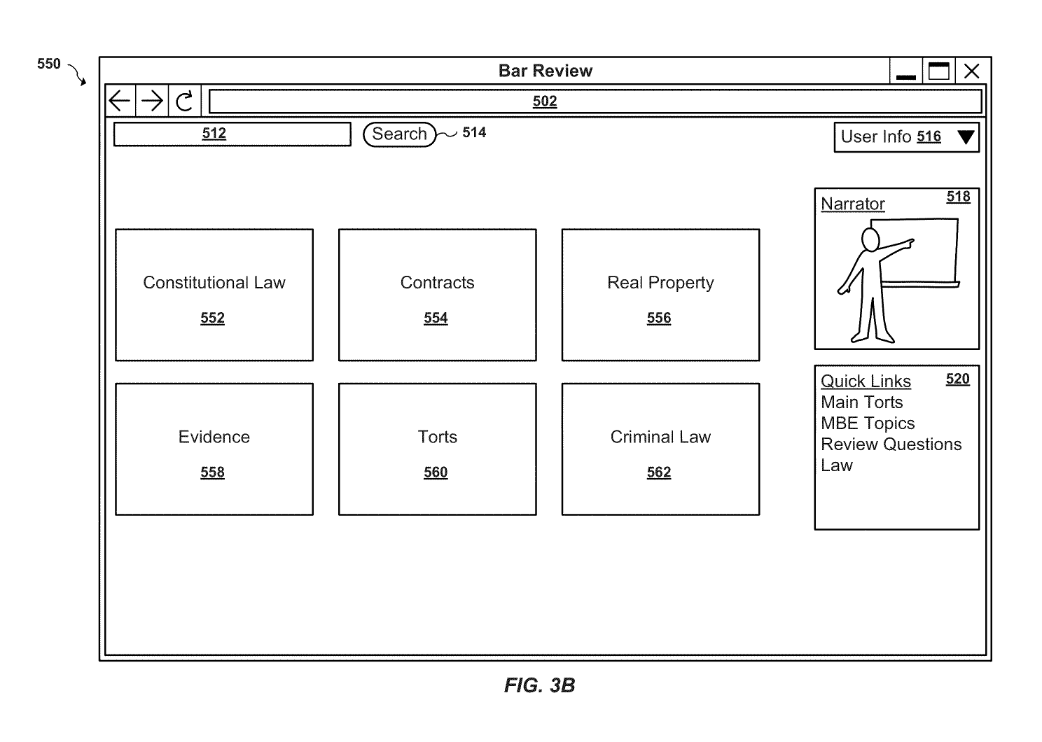

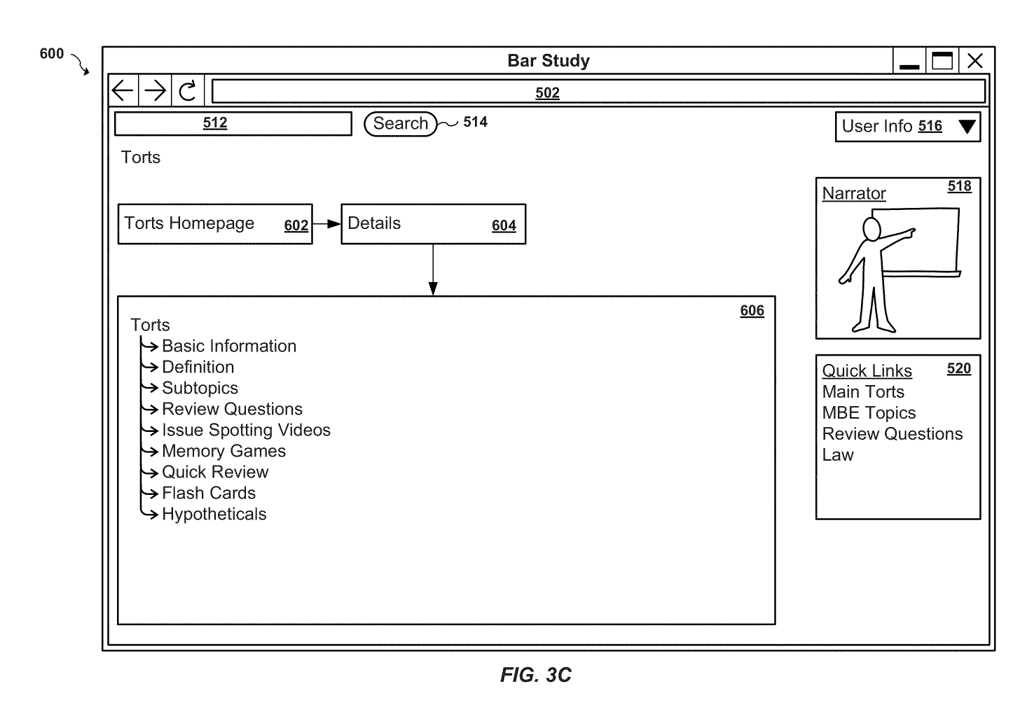

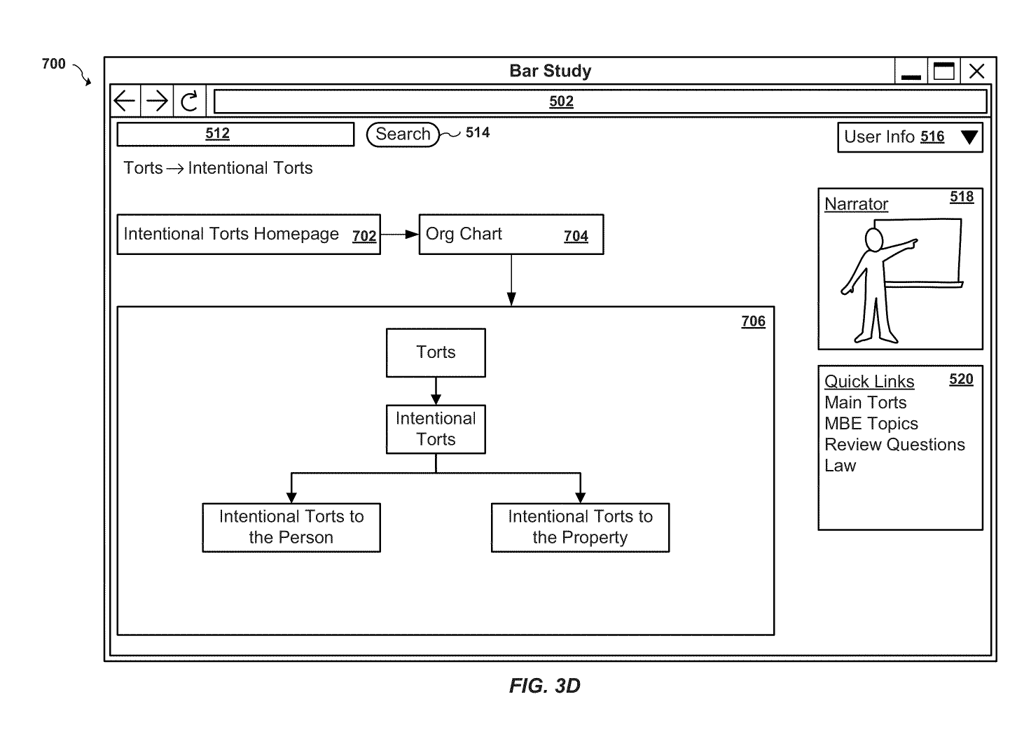

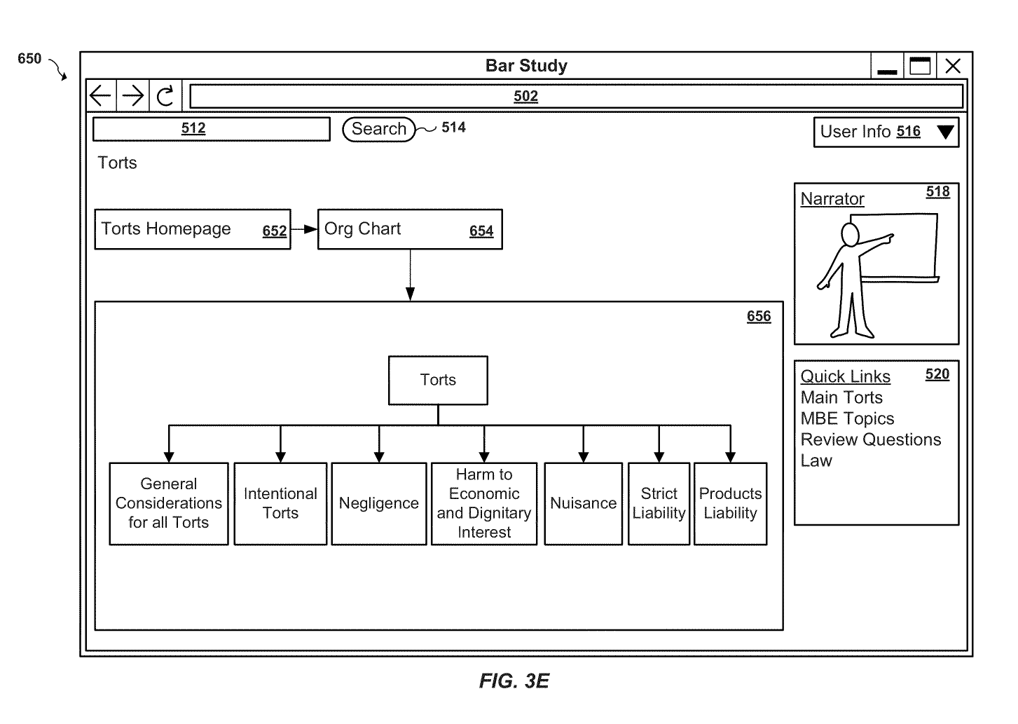

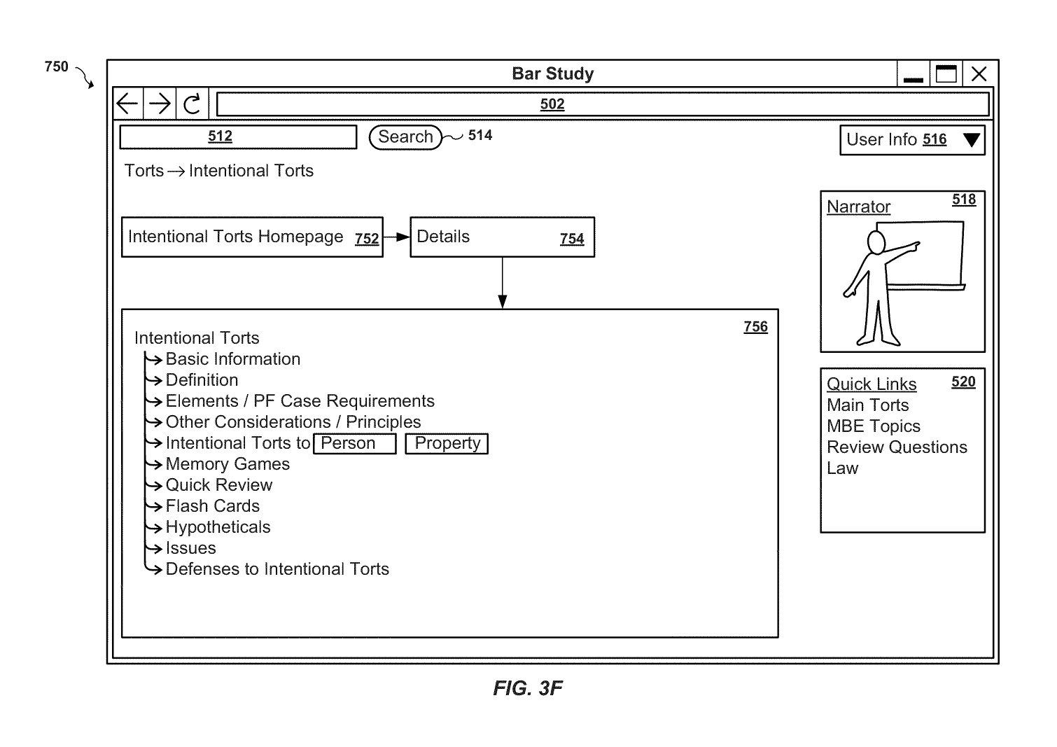

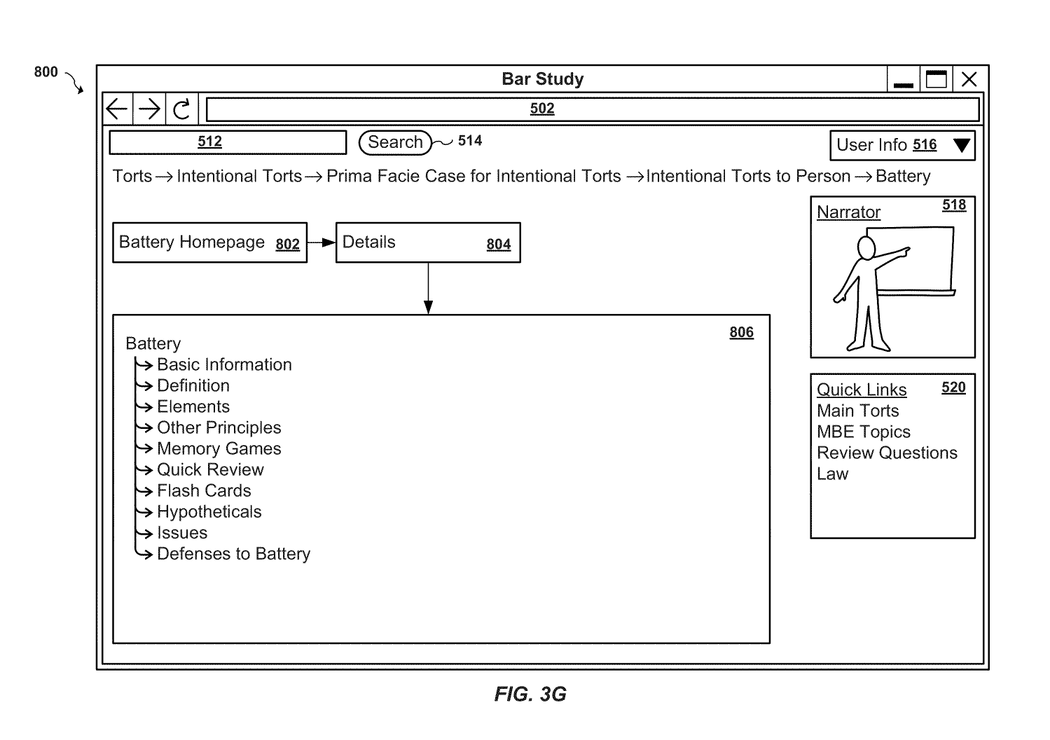

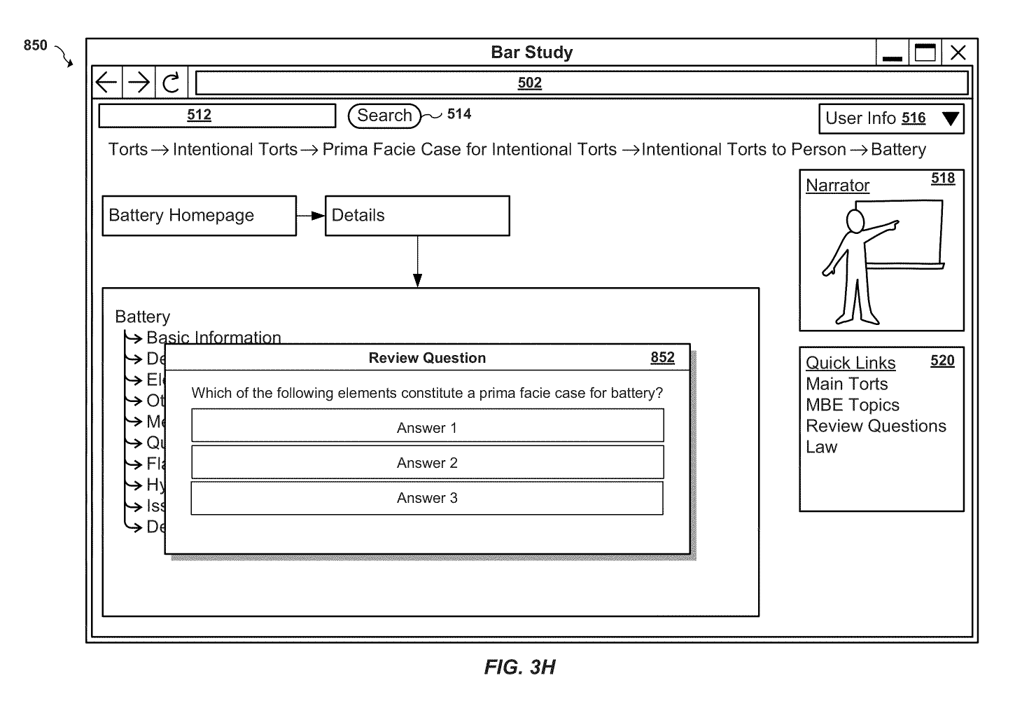

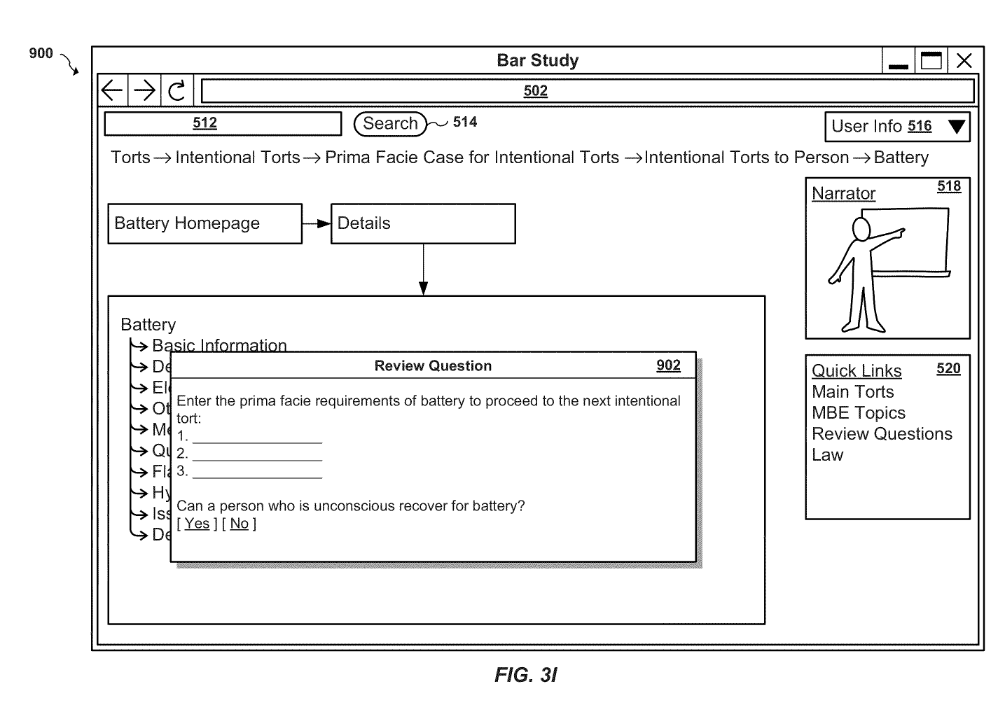

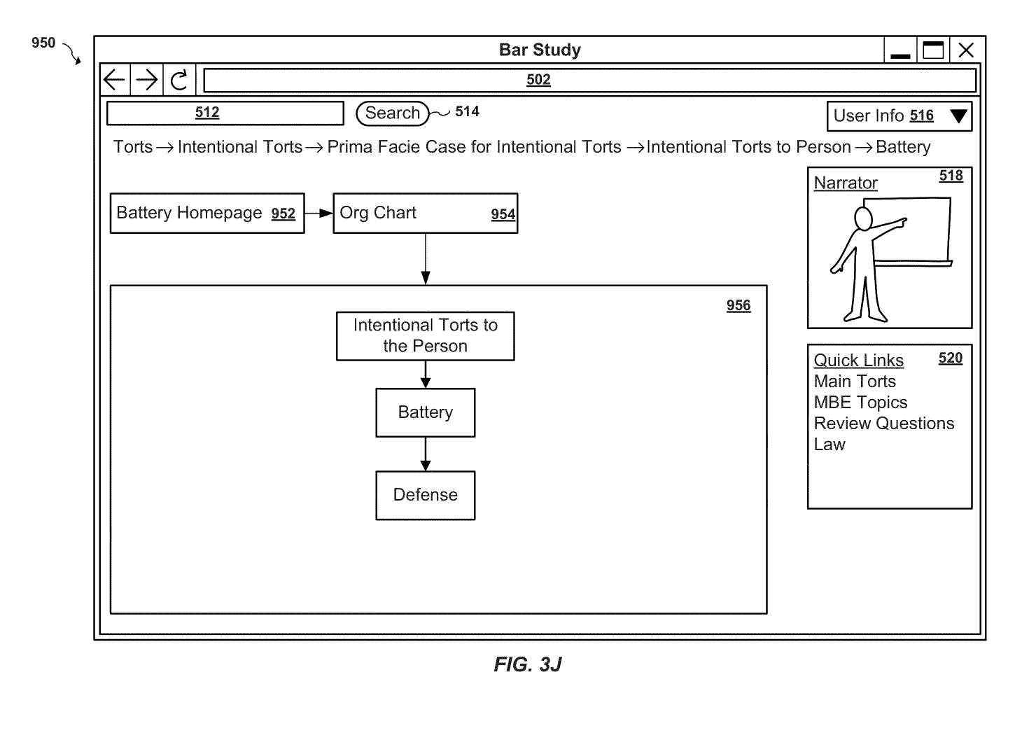

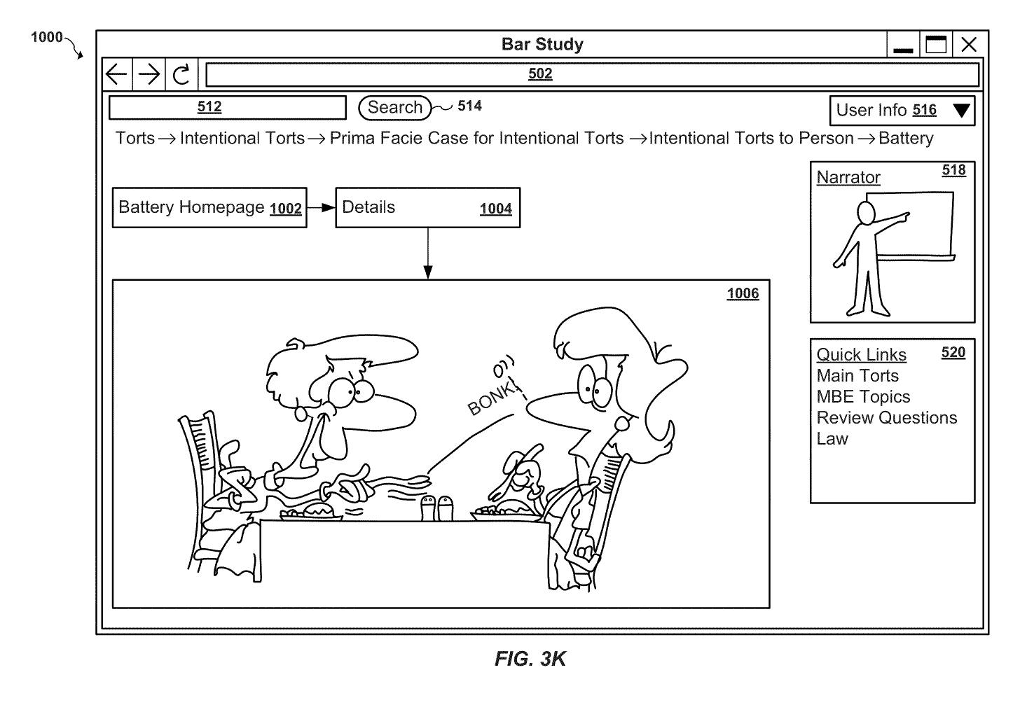

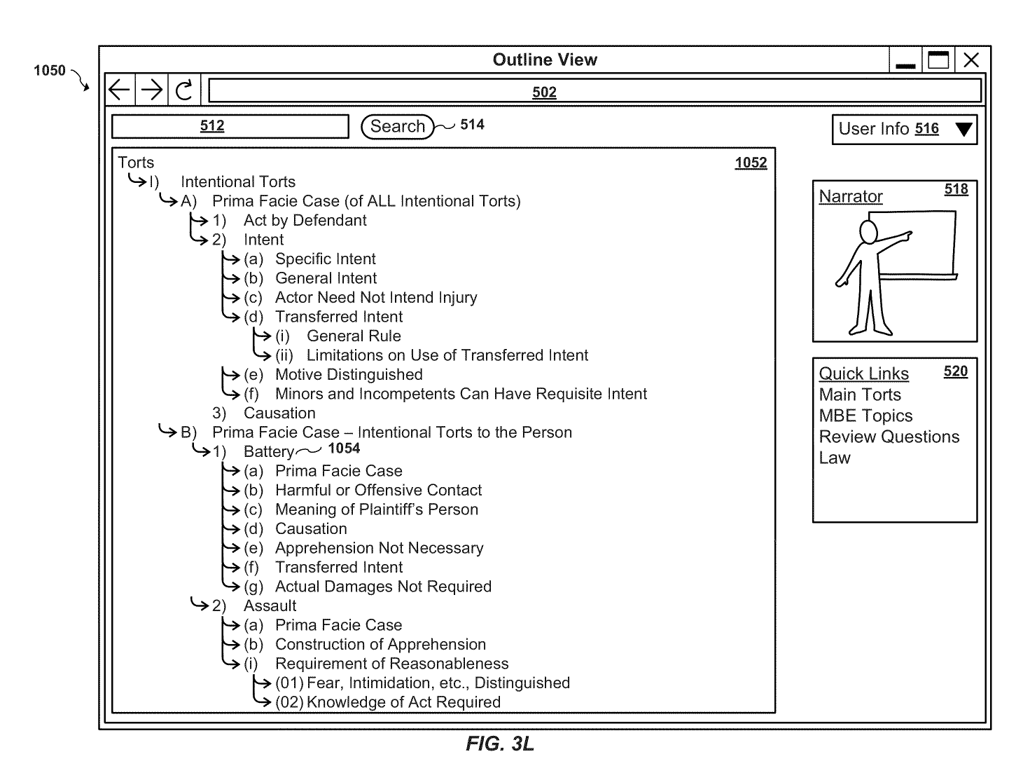

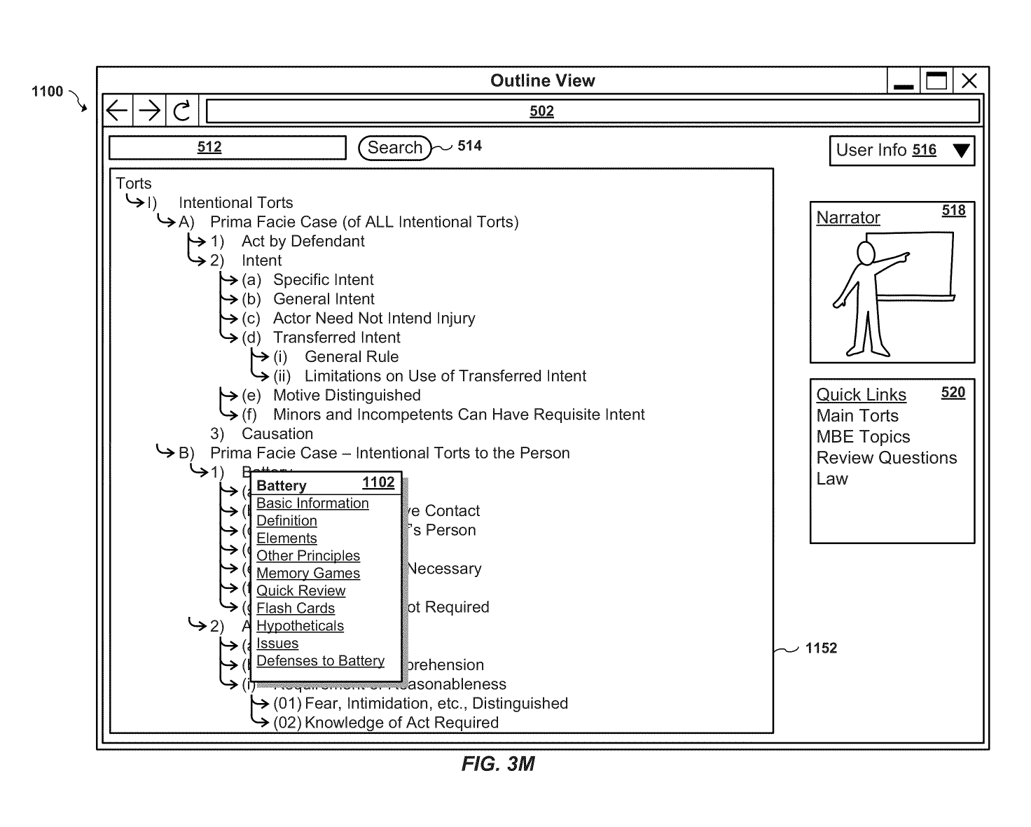

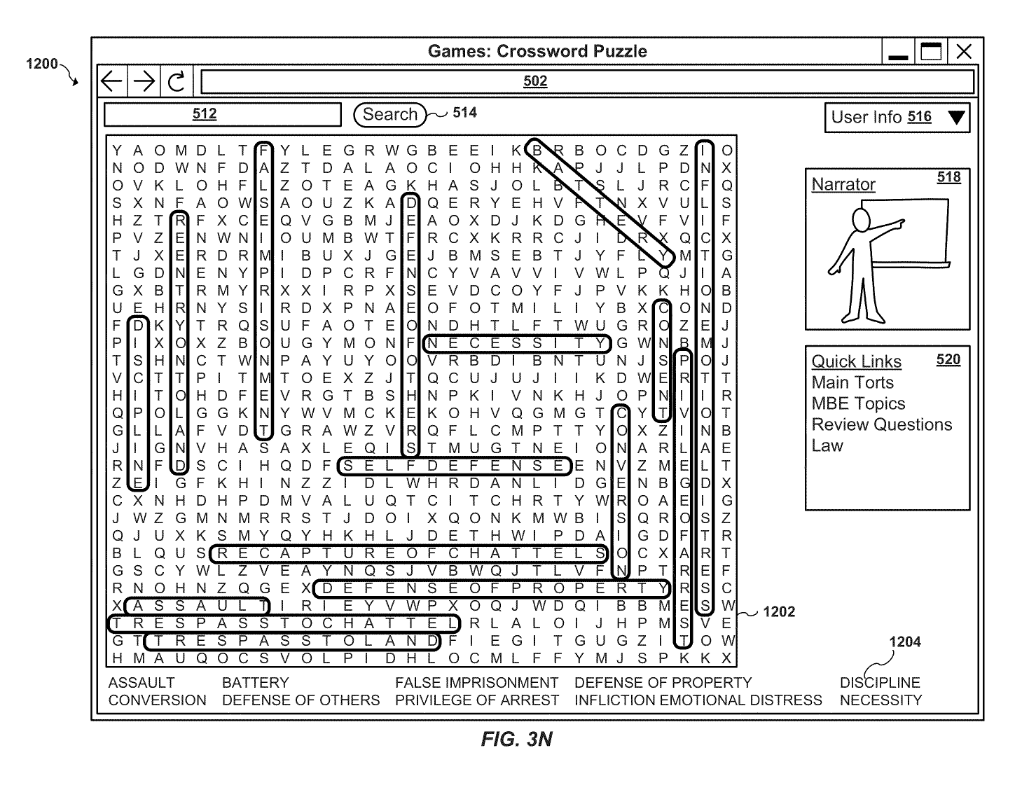

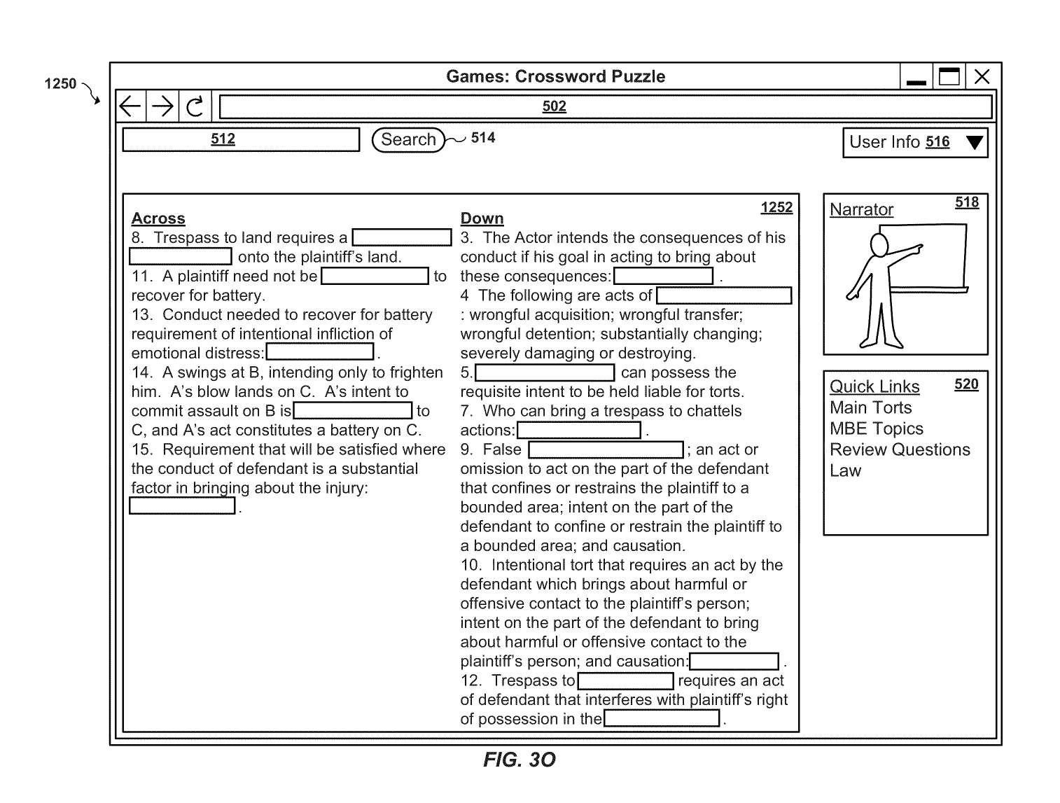

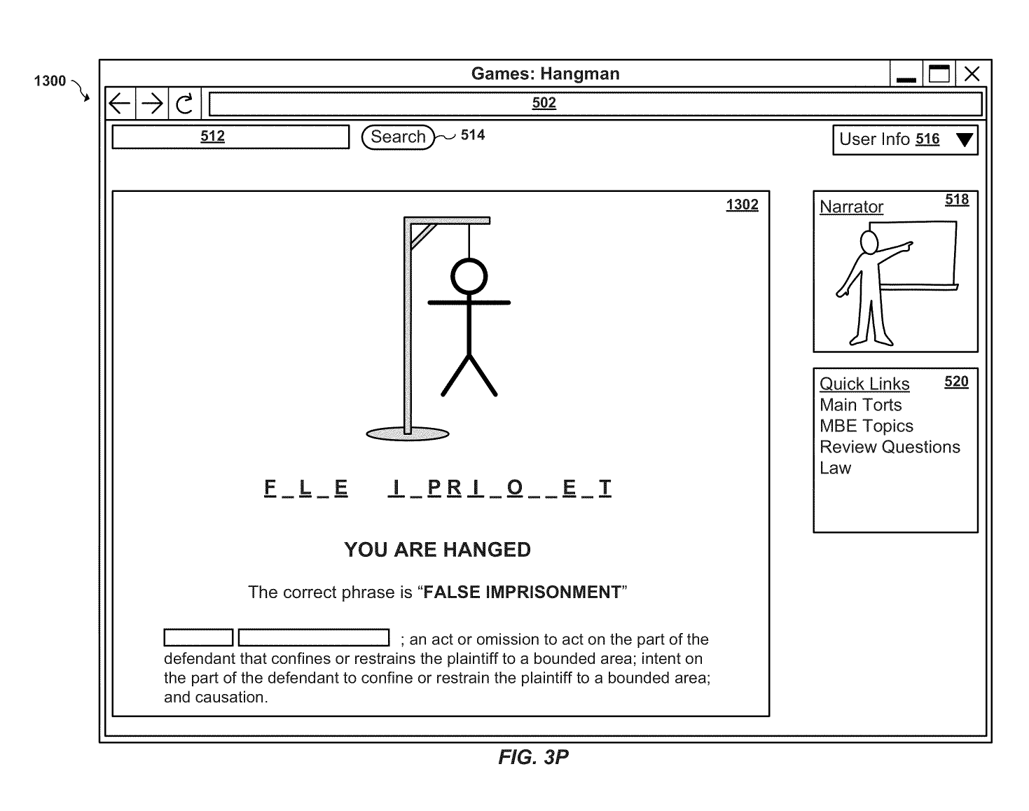

The system 100 includes an animation/video and audio module 210 that plays or outputs animation and/or video files or data. The speed at which the animation and/or video files or data are played may be manipulated by the user 101, instructor 102 and/or administrator 103 using a user interface of the system 100. According to one embodiment, a user 101 of the system 100 may log onto a web page associated with a network-enabled device and output the animation and/or video files or data. The animation and/or video files or data are graphically displayed on the web page. For example, an animation/video similar to the one shown in area 1006 of FIG. 3K may be displayed. The animation/video is used to provide the user 101 a more engaging and entertaining means of learning a particular topic, subtopic and/or element. This is accomplished by means of linking animation/video files and/or data (e.g., animation/video data in a database or a stream of animation/video data transmitted across a network) to topics, subtopics and/or elements which the student desires to learn. For example, the intentional tort of battery includes the elements of intentional harmful or offensive contact to a person. Each of these elements individually or collectively may be represented by individual or multiple animations/videos in which the animation/video files and/or data is linked to the particular element. These animations/videos may be hot swapped during the execution of the system 100, such that animations/videos may be inserted, replaced or removed. If multiple animations/videos are specified, then the system 100 may be configured to play one or more of those animations/videos sequentially or randomly. The animations/videos may also be dynamically generated or rendered by the animation/video and audio module 210. Optionally, a cartoon book may be printed from a data file or a printed version of the animation and/or video files may be dynamically generated in a cartoon book format.

The animation/video and audio module 210 also plays audio files or data. The audio files or data may be played separately or in conjunction with a corresponding animation file. The speed at which the audio files or data are played may be manipulated by the user 101, instructor 102 and/or administrator 103 using a user interface of the system 100. The audio file or data may be generated by any traditional means or may be optionally generated using text to voice software.

Referring to FIG. 2C, a flow chart illustrating the animation/video and audio module 210 for providing educational services in accordance with an embodiment of the present invention, is shown. At block 212, the system 100 receives one or more animation/video and/or audio files. The animation/video and/or audio files are loaded onto the one or more computers and/or servers 106 or the one or more databases 110. A system administrator may load the one or more animation/video and/or audio files using a user interface provided by the system 100 or may load these files manually. The user interface may be accessed locally on the computers and/or servers 106 or remotely from a web browser using a secure socket connection to a web server running on the system 100.

The one or more animation/video and/or audio files or data are then linked to a field of study, topic, subtopic, and/or element in the hierarchical outline structure. An administrator 103 may link the one or more animation/video and/or audio files or data using a user interface provided by the system 100. According to one non-limiting embodiment, the animation/video and/or audio files are loaded in a pre-defined directory and the file names are associated with the respective field of study, topic, subtopic, and/or element in the animation/video and audio database 118. Thereby, the system 100 is configured to allow the animation/video and/or audio files to be hot-swappable while the system 100 is operational simply by either (i) replacing the respective file on the one or more computers and/or servers 106 or the one or more databases 110 with the another file of the same name, or by (ii) changing the file name in the animation/video and audio database 118. According to an alternate embodiment, multiple animation/video and/or audio files or data may be linked to a particular field of study, topic, subtopic, and/or element. According to this alternate embodiment, the system 100 may be configured to either sequentially rotate through the multiple files or randomly play one or more of the multiple files to provide variety.

### Outline Module

The system 100 includes an outlines module 300 that outputs data in an outline format. The outline may be graphically displayed on the web page, output orally using text to voice software, and/or printed. For example, an outline similar to the one shown in FIG. 3L may be displayed. The outline may also be dynamically generated based on topic areas selected or deselected by the user 101. In this way, the user 101 may focus on those areas of the outline in which the user 101 needs additional learning or ignore areas in which the user 101 does not have an interest.

Referring to FIG. 2D, a flow chart illustrating the outlines module 300 for providing educational services in accordance with an embodiment of the present invention, is shown. At block 302, the system 100 provides a user interface that allows navigation through the topics, subtopic, and/or elements. According to one embodiment, the navigation is presented, without limitation, in an outline format and/or an organizational chart. The topic is presented to the user 101 at block 304. Optionally, a subtopic is presented to the user 101 at block 306. Traversal of fields of study, topics, subtopics and elements is accomplished using the field object, topic object, and element object as shown in FIG. 1D. The topic object and element object include a level identifier which may be used to programmatically indicate the level of the object within the hierarchical structure to be traversed. For each element, an animation/video and/or audio file is presented to the user 101 at blocks 308-312. The animation/video and/or audio file or data (a media content object) is associated with the field of study, topic, and element objects shown in FIG. 1D. The animation/video and/or audio file or data associated with the selected field of study, topic, and/or element object is presented to the user 101. At block 314, a review of the topic/subtopic/element is presented to the user 101. This review may include, without limitation, question popup dialogs similar to ones shown in FIGS. 3H-3I, which the user 101 may be required to answer before proceeding to the next topic/subtopic/element.

### Review Module

The system 100 includes a review module 330 for presenting information that needs to be learned and/or memorized to the user 101. The information may be graphically displayed, printed or may be output orally using text to voice software. According to one embodiment, the user 101 is required to answer one or questions associated with a particular topic or portion thereof before proceeding to the next topic or portion (see, e.g., FIGS. 3H-3I).

### Games Module

The system 100 includes a games module 360 that outputs interactive games to the user 101. The games may be graphically displayed, printed or may be output orally using text to voice software. The games include without limitation a crossword puzzle, a word guess game, a flash card game, a definition cross reference game, a find the missing element game, a wheel of fortune game, a hangman game, and the like. For example, a crossword puzzle game is shown in FIG. 3N in which the user 101 finds elements, terms or definitions related to a topic/subtopic and the like. According to one embodiment, a user 101 of the system 100 may log onto a web page associated with a network-enabled device and play the game. According to an alternate embodiment, the games module may be presented in a standalone configuration.

### Practice Test Module

The system 100 includes a practice test module 390 that presents tests to the user 101. The outline may be graphically displayed, printed or may be output orally using text to voice software. Depending on the configuration settings as set by the system administrator and the options of the user 101, the test may be timed or untimed. The timing attributes are also configurable by the user 101, instructor 102 and/or administrator 103. The user's 101 testing results for the entire test, and/or each topic, subtopic, and/or element are stored in the historical user testing information 124. According to one embodiment, the user 101, instructor 102 and/or administrator 103 may select which topics, subtopics, and/or elements to include. According to another embodiment, the percentage of testing questions may be based on the results of the user's testing results that are stored in the historical user testing information 124 and/or statistical information from previous tests from the testing entity, organization or instructor 102 (e.g., previous MPRE or state bar exams). Thereby, the test questions can be focused on areas in which the user 101 is having difficult and/or areas which are more likely to be asked by the testing entity, organization or instructor 102.

According to one embodiment, the practice test module 390 includes a dynamic practice test generator that may be utilized in the dynamic creation of practice tests based on the configuration settings as set by the administrator 103 and/or instructor 102 and the options of the user 101. The practice tests may be provided electronically via a viewer such as without limitation a standard internet browser. Alternatively, the practice tests may be provided in a printed form. The practice test scores are stored in historical information database 118.

### Progress Report Module

The system 100 includes a progress report module 420 that may be utilized in the dynamic creation of reports. The progress report module 420 dynamically builds a report for the user 101 that details their practice test results over time. The report is dynamically produced whenever the user 101 and/or instructor 102 requests it and is presented in a report viewer such as without limitation a standard internet browser. The report may be in the form of a graphical chart or table and may be displayed electronically or in a printed form. The dynamic nature of the report generation allows the user 101 and/or instructor 102 to receive the latest up-to-date practice test data every time the user 101 and/or instructor 102 requests to view the report. This is accomplished by using the practice test scores to compile a report from the historical information database 118.

### Open Forum Module

The system 100 includes an open forum module 450 that allows users 101 to communicate with each other and/or the instructor 102 about a particular topic using a graphical user interface similar to a message board. Using the open forum module, the users 101 may ask other users and/or the instructor 102 questions, respond to the questions of other users, or post comments regarding a particular test or topic.

FIGS. 3A-3P illustrate exemplary user interfaces for providing educational services in accordance with an embodiment of the present invention. It is understood that other user interfaces are possible within the scope of the invention. According to one embodiment, when an administrator logs into the system 100, the administrator is presented with a graphical user interface that allows the administrator to configure the system 100.

### Previous Testing Information Module

The system 100 includes a previous testing information module 480 that allows a user 101 to view previous tests and/or statistical information from previous tests from the testing entity, organization or instructor 102 (e.g., previous MPRE or state bar exams). The statistical information includes without limitation the frequency and dates of previous questions for each topic, subtopic and/or element. According to one embodiment, the statistical information is used by the practice test module 390 to dynamically generate practice test questions based on the frequency and trends of previous tests.

### III. Exemplary User Interfaces

According to one embodiment, when a user 101 logs into the system 100, the user 101 is presented with graphical user interfaces similar to the exemplary graphical user interfaces shown in FIGS. 3A-3P. According to one possible non-limiting implementation, the menu options include, without limitation, “Bar Review” 506, “MPRE” 508, and “Law School Study” 510. Obviously, the menu options are dictated by the particular area of study. As such, the topic areas are presented for exemplary purposes and other menu options are possible within the scope of the present invention. The user interface may also include a search capability (512 and 514), and user information 516, a narrator 518 and quick links 520 areas. The search capability (512 and 514) allows the user 101 to search the system 100 for terms, fields of study, topics, subtopics, elements, and the like. The user information 516 may be, without limitation, a pull-down menu which allows the user to edit, without limitation, user options and preferences, user profile information (including username and password information), and the like.

The narrator 518, which may or may not be represented by a cartoon character or other image, provides oral dictation of information related to the particular field of study, topic, subtopic and/or element. The oral dictation may include animation and/or video.

The quick links 520 include links to information related to the particular field of study, topic, subtopic, and/or element. For example, the quick links 520 may include a link to one or more topics, review questions, areas of law, and the like.

If the user 101 selects “Bar Review” 506, the user 101 may be presented with a graphical user interface similar to the graphical user interface shown in FIG. 3B. According to one possible non-limiting implementation, the menu options include, without limitation, “Constitutional Law” 552, “Contracts” 554, “Real Property” 556, “Evidence” 558, “Torts” 560, and “Criminal Law” 562. Obviously, it is understood that the menu options are dictated by the particular field of study. Further, the user may also be presented with multiple fields of study in which to select, such as without limitation, law, medicine, engineering, and the like, or may be limited to a particular field of study depending on the user permissions. By selecting one of these menu options, the user 101 is presented with graphical user interfaces similar to the exemplary graphical user interfaces shown in FIGS. 3C-3P.

Each user 101 having the appropriate permission has the ability to drill down from a particular topic to the individual elements of the particular topic using a simple to use, intuitive interface. For example, as shown in FIG. 3L, the user 101 may drill down from a particular topic to the individual elements simply by clicking on it. The system 100 is also configured to provide access to the practice tests, games, media content, flash cards, outlines, and the like simply by drilling down to a particular field of study, topic, subtopic, element, and the like. The system 100 may include a popup capability by clicking (or using a particular key combination) on a line having this capability. For example, as shown in FIGS. 3L and 3M, clicking on the Battery link 1054 may display a popup 1101 which allows the user to select, without limitation, basic information, definition, elements, other principles, memory games, quick review, flash cards, hypotheticals, issues, defenses, and the like.

As shown in FIG. 3C, according to one possible implementation, the user 101 may be presented with details 604 of a particular topic 602. As shown in area 606, the topics may include, without limitation, basic information, definitions, subtopics, review questions, issue spotting videos, memory games, quick review, visual/audio flash cards, word hypotheticals, and the like.

As shown in FIG. 3D, according to one possible implementation, the user 101 may be presented with an organizational chart 704 of a particular topic 703. An exemplary organizational chart is shown in area 706. The organizational chart allows the user 101 to navigate from a topic to a subtopic, and continuing to an element.

As shown in FIGS. 3H and 3I, at the completion of a particular field of study, topic, subtopic, element, and the like, the system 100 may display a popup (852 and/or 902) which the user 101 must complete before continuing on to the next section. For example, clicking on the “Yes” or “No” links will return the user 101 to the torts homepage or give the user the option to further review the current subject by reading an outline, watching videos or additional text. This feature may be enabled or disabled by the user 101 using the user info pull-down 516 to turn on or off review mode.

### IV. Other Modifications and Variations

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, device, or computer program product. Accordingly, the present invention may take the form of an entirely hardware embodiment or an embodiment combining software and hardware aspects all generally referred to herein as a “circuit” or “module.”

The present invention thus includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in an object oriented programming language such as Java®, Smalltalk, C# or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for providing educational services, the system comprising:
a plurality of remote computers;
a central server;
a network interface in communication with the central server and the plurality of remote computers over a network, the network interface being configured to provide educational services;
a shared database in communication with the central server;
wherein the central server is configured to:
receive and store educational information in the shared database, wherein the educational information comprises a plurality of outlines and a plurality of animation data, wherein the outlines include one or more topics, each topic having one or more elements, and wherein the one or more elements are linked to one or more of the plurality of animation data;
load the linked one or more animation data from the shared database when the user selects at least one of the one or more elements corresponding to the linked one or more animation data; and
play the loaded one or more one or more animation data on at least one of the plurality of remote computers.

2. The system of claim 1, wherein the central server is configured to receive and store topic review information in the shared database, wherein receiving and storing topic review information in the shared database comprises presenting questions and receiving responses to the questions, and wherein the questions and the responses to the questions are related to the linked one or more animation data and the one or more topics.

3. The system of claim 1, wherein the educational information further comprises one or more games.

4. The system of claim 3, wherein the one or more games comprises at least one selected from the group consisting of crossword puzzle, a word guess game, a flash card game, a definition cross reference game, a find the missing element game, a wheel of fortune game, and a hangman game.

5. The system of claim 2, wherein the questions and responses related to the linked one or more animation data comprise multi-state bar exam questions and responses.

6. The system of claim 2, wherein the educational information further comprises statistical information related to correct responses to the questions in the related the one or more topics.

7. The system of claim 6, wherein the questions in the related the one or more topics are presented based on the statistical information.

8. The system of claim 7, wherein the statistical information is presented in a graphical chart over time.

9. The system of claim 2, wherein the questions and responses to the questions comprise multi-state bar exam questions and responses.

10. The system of claim 2, wherein the questions and responses to the questions comprise law school questions and responses.

11. The system of claim 2, wherein the questions and responses to the questions comprise law bar exam questions and responses.
The system of claim 1, wherein the educational information further comprises audio data.

12. The system of claim 2, wherein the educational information further comprises test questions and responses to previous examinations.

13. The system of claim 1, wherein the plurality of animation data comprises Flash files.

14. The system of claim 1, wherein the plurality of animation data is dynamically generated.

15. A computer program product embodied on a non-transitory computer readable medium for providing educational services, wherein the computer program is implemented by one or more processors executing processor instructions, the computer program product comprising:
a first computer code for receiving configuration and setup information, wherein the configuration and setup information includes a plurality of outlines, games and animation files, wherein the outlines include one or more topics, each topic having one or more elements, and wherein one or more of the elements is linked to the animation files;
a second computer code for displaying one or more of the plurality of animation files to the user when one or more of the elements are selected;
a third computer code for receiving and storing practice test information in the database, wherein the practice test information includes responses to practice test questions; and
a fourth computer code for presenting one or more practice tests to the user.
